(19) United States
(12) Patent Application Publication
(10) Pub. No.: US 2012/0109660 A1
(43) Pub. Date: May 3, 2012

(54) Integrated process and system for cosmetic vehicle repairs

(76) Inventors: Gann Xu, Boothwyn, PA (US); Keith A. Sena, Canton, MI (US); Michael W. McMillan, Newark, DE (US); Jonathon P. Purifoy, Chicago, IL (US); Jon Kemp, Middletown, DE (US); Allan Blase Joseph Rodrigues, Bloomfield Hills, MI (US); Daniel A. Benton, Wilmington, DE (US); Joseph Francis Campbell, Shelby Township, MI (US)

(21) Appl. No.: 12/288,642

(22) Filed: Oct. 22, 2008

Related U.S. Application Data
(60) Provisional application No. 60/999,966, filed on Oct. 23, 2007.

(51) Int. Cl. G06Q 10/00; G06F 17/30

(52) U.S. Cl. 705/1.1; 707/769; 707/E17.014

(57) ABSTRACT

The present invention is directed to an integrated process and system for cosmetic vehicle repair. The invention provides a process and a system to produce repair formulas, repair estimates, and repair scheduling. The present invention is particularly directed to a process and a system for repairing coating defect of a vehicle.

### FIELD OF INVENTION

The present invention is directed to an integrated process and a system for repairing cosmetic defects of a vehicle. This invention is further directed to a process and a system for repairing coating defects of a vehicle.

### BACKGROUND OF INVENTION

Cosmetic defects of a vehicle are visible and non-structural defects or flaws in interior or exterior parts of the vehicle that are caused by mechanical or chemical actions or by atmospheric conditions. Such cosmetic defects include dents on the body of the vehicle, carpet or upholstery damages, glass or windshield cracks. The defects also include chipping, discoloration, scratches, small blemishes, color deterioration, or other defects or damages of surface coatings of the vehicle.

Surface coatings of vehicles can utilize one or more pigments or effect pigments to impart the desired color or appearance, such as solid, metallic, pearlescent effect, gloss, or distinctness of image, to vehicle bodies. Repair of such surface coatings that have been damaged, e.g., in a collision or stone chipping or scratches, has been difficult in that a vehicle repair body shop or a refinisher may have to go to great lengths to repeatedly try out and to locate a best aftermarket refinish coating composition that matches the color and appearance of the vehicle's original coating, also known as original equipment manufacturing (OEM) coating.

Various color matching techniques have been developed in the past to aid the selection of the correct matching coating composition to refinish a vehicle. An example of such color matching techniques was disclosed in U.S. Pat. No. 7,145,656. Said method, however, requires measured color values and cannot identify matching formulas based on vehicle identification information. Another example is to use both measured color values and vehicle identifying information to locate potential preliminary matching formulas from a refinish matching coating database. One example of such system was disclosed in U.S. Pat. No. 6,522,977. However, the preliminary matching formulas need to be adjusted manually and repeatedly by trial and error until a match is achieved.

Providing an accurate repair estimate for repairing one or more defects of a vehicle of a customer is important and challenging. Accurate repair cost estimate is important to the repair business. Too high an estimate may turn away a customer while too low one may not cover the actual cost. Traditionally, an inspector from a vehicle repair shop takes notes while inspecting the vehicle in a parking lot, an inspection Bay, or other space where the vehicle is parked, for locations, nature and levels of damages or defects of the vehicle. Then the inspector goes to a separate space such as an office area and utilizes reference materials, such as price lists, manuals, handbooks or online databases to identify list prices for repairing each of the inspected damages or defects. For a vehicle with multiple damages or defects of different nature, such as coating defects, interior damages, or glass damages, the inspector has to locate right reference materials or databases by spending significant amount of time and efforts. Since different vehicles may require different repairing process, repairing material or optionally repair labor, the inspector needs to obtain information that is vehicle specific for generating an accurate repair estimate. The inspector then needs to calculate the total auto repair cost manually. Such traditional method is laborious and time consuming and often leads to inaccurate estimates. In addition, since inspection and calculation of costs occurs at separate areas, it often leads to omission or misjudgment of some defects.

Once the repair estimate is generated, a repair time schedule for repairing the vehicle also needs to be generated. Traditionally, the inspector will hand over the scheduling task to another person in the vehicle repair shop who then schedules the repair on a paper or through an electronic scheduler and provide a written reminder to the customer for the scheduled repair time. Typically, it is also necessary to notify a repair group of the shop so that appropriate resources are available for repairing the vehicle at the scheduled repair time. This traditional process requires additional personnel at the vehicle repair shop and often results in delay and causes the customer to wait for a period of time.

Vehicle repair and vehicle insurance industries have developed some methods to improve vehicle repair estimate process. Most of vehicle repair shops are using pre-printed estimate forms with most common defects and damages listed. Cost for repairing each defect or damage on the list is often provided. The inspector generally makes check marks on the repair form for the listed defects and damages while inspecting a vehicle and then totals up the costs to get a total repair estimate. One major disadvantage of pre-printed forms is that it is difficult to provide specific vehicle data based on the make, model, manufacturing year or body style of the vehicle. In addition, the pre-printed forms lack the ability to have dynamic updates on vehicle data and cost changes. U.S. Pat. No. 5,317,503 attempt to address the foregoing issues through an apparatus for calculating a repair cost of a damaged vehicle. The apparatus, however, requires the user to manually input vehicle data, such as make, model, body style, etc. The apparatus uses a CD-ROM as data source which lacks the ability to have dynamic update on vehicle data and cost change. Further more, the apparatus is typically positioned at a fixed location and is not suitable for mobile use during inspection and estimating process. In addition, the apparatus does not have means for scheduling the repair once the repair estimate is completed.

Thus, a continuing need still exists for a process and a system to repair cosmetic defects of a vehicle with minimum requirement for repeated testing, manual adjustment and trial and to provide accurate cost estimate for the repair.

### STATEMENT OF INVENTION

This invention is directed to a method for repairing one or more cosmetic defects of a vehicle of a customer, said method comprising the steps of:

(A) entering vehicle identification data of the vehicle into a computing device to retrieve vehicle data from a vehicle database accessible from the computing device based on the vehicle identification data;

(B) obtaining individual damage data of said cosmetic defects;

(C) entering the individual damage data into the computing device;

(D) obtaining individual repair data from the computing device based on the individual damage data and the vehicle data;

(E) generating individual cost data from the computing device based on the individual damage data and the individual repair data;

(F) generating a repair selection by specifying whether each of said defects is to be repaired;

(G) generating a repair estimate from the computing device based on the individual damage data, the individual cost data and the repair selection; and

(H) repairing said cosmetic defects based on the repair data and the repair selection.

This invention is also directed to a system for repairing one or more cosmetic defects of a vehicle of a customer, said system comprising:

(A) a computing device comprising a memory member;

(B) at least one data input device and at least one data output device, wherein said data input and output devices are functionally coupled to said computing device;

(C) at least one display device functionally coupled to said computing device;

(D) one or more databases accessible from said computing device;

(E) a color measuring device, and optionally, an appearance measuring device; and

(F) a computing program product operatively residing in said memory member that causes the computing device to perform a computing process comprising the steps of:
(1) receiving vehicle identification data of the vehicle from the data input device;
(2) retrieving vehicle data from a vehicle database accessible from the computing device based on the vehicle identification data;
(3) receiving individual damage data of said cosmetic defects;
(4) generating individual repair data based on the individual damage data and the vehicle data;
(5) retrieving individual cost data based on the individual damage data and the individual repair data;
(6) generating a repair selection by displaying a repair selection question and receiving repair selection input to said repair selection question specifying whether each of said defects is to be repaired;
(7) generating a repair estimate based on the individual damage data, the individual cost data and the repair selection;
(8) optionally, generating a repair schedule for repairing at least one defect specified in the repair selection input; and
(9) outputting the repair data, the repair estimate, or a combination thereof.

### BRIEF DESCRIPTION OF DRAWING

FIG. 1 shows a representative flow chart of the process of this invention.

FIG. 2 shows a representative flow chart on selecting matching formulas for repairing a coating defect.

FIG. 3 shows another representative flow chart on selecting matching formulas for repairing a coating defect.

FIG. 4 shows yet another representative flow chart on selecting matching formulas for repairing a coating defect.

FIG. 5 shows yet another representative flow chart on selecting matching formulas for repairing a coating defect.

FIG. 6 shows representative examples of screenshots for entering damage data into a computing device. (A) A screenshot with a diagram of a vehicle body and a representative data input layout. (B) A screenshot with a diagram of an interior of a vehicle and a representative data input layout.

FIG. 7 shows representative examples of color image display. (A) An image of target color and an image of a matching color are displayed side-by-side. (B) An image of target color and an image of a matching color are displayed immediately adjacent to each other.

FIG. 8 shows representative examples of realistic color image display. (A) A realistic image of target color and a realistic image of a matching color are displayed side-by-side. (B) A realistic image of target color and a realistic image of a matching color are displayed immediately adjacent to each other. (C) A realistic image of target color and a realistic image of a matching color are displayed immediately adjacent to each other with a blending area between them.

FIG. 9 shows representative screenshots for displaying color images. (A) Realistic images are displayed as curved views. (B), (C) and (D) color images are displayed at three different viewing angles.

FIG. 10 shows examples of hardware configurations of the system of the invention.

### DETAILED DESCRIPTION

The features and advantages of the present invention will be more readily understood, by those of ordinary skill in the art, from reading the following detailed description. It is to be appreciated that certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

As used herein:

The term “cosmetic defects” refers to visible defects of a vehicle that are non-structural. Cosmetic defects may include coating and paint defects, dents of a vehicle body, vehicle interior surface and finish damages, glass and windshield damages, vehicle exterior surface damages, or a combination thereof. Cosmetic defects may also include flaws and other visible non-structural defects of the vehicle that are caused by mechanical or chemical actions or by atmospheric conditions, e.g., hail or acid rain.

The term “customer” used herein refers to a person or persons, an agency, or an entity who requests repair of the vehicle. A customer may be the owner of the vehicle or a representative or an agent of the owner. The customer may also be a person, an agency, or an entity who has temporary possession or responsibility of the vehicle, such as a person who rents a rental car.

The term “pigment” or “pigments” used herein refers to a colorant or colorants that produce color or colors. A pigment can be from natural and synthetic sources and made of organic or inorganic constituents. A pigment also includes metallic particles or flakes with specific or mixed shapes and dimensions. A pigment is usually not soluble in a coating composition.

The term “effect pigment” or “effect pigments” refers to pigments that produce special effects in a coating. Examples of effect pigments include, but not limited to, light scattering pigments, light interference pigments, and light reflecting pigments. Flakes, such as metallic flakes, for example aluminum flakes, are examples of such effect pigments. Effect pigments can also include gonioapparent flakes which change color or appearance, or a combination thereof, with changing in illumination angles or viewing angles. Metallic flakes, such as aluminum flakes are examples of gonioapparent flakes.

The term “dye” means a colorant or colorants that produce color or colors. Dye is usually soluble in a coating composition.

“Appearance” used herein refers to (1) the aspect of visual experience by which a coating is viewed or recognized; and (2) perception in which the spectral and geometric aspects of a coating is integrated with its illuminating and viewing environment. In general, appearance includes visual texture such as coarseness caused by effect pigments, sparkle, or other visual effects of a coating, especially when viewed from varying viewing angles and/or with varying illumination angles.

The term “database” refers to a collection of related information that can be searched and retrieved. The database can be a searchable electronic numerical, alphanumerical or textual document; a searchable PDF document;

a Microsoft Excel® spreadsheet; a Microsoft Access® database (both supplied by Microsoft Corporation of Redmond, Wash.); an Oracle® database (supplied by Oracle Corporation of Redwood Shores, Calif.); or a Linux database, each registered under their respective trademarks. The database can be a set of electronic documents, photographs, images, diagrams, or drawings, residing in a computer readable storage media that can be searched and retrieved. A database can be a single database or a set of related databases or a group of unrelated databases. “Related database” means that there is at least one common information element in the related databases that can be used to relate such databases. One example of the related databases can be Oracle® relational databases.

The term “vehicle”, “automotive”, “automobile”, “automotive vehicle”, or “automobile vehicle” refers to an automobile such as car, van, mini van, bus, SUV (sports utility vehicle); truck; semi truck; tractor; motorcycle; trailer; ATV (all terrain vehicle); pickup truck; heavy duty mover, such as, bulldozer, mobile crane and earth mover; airplanes; boats; ships; and other modes of transport that are coated with coating compositions.

A computing device used herein refers to a desktop computer, a laptop computer, a pocket PC, a personal digital assistant (PDA), a handheld electronic processing device, a smart phone that combines the functionality of a PDA and a mobile phone, an iPod, an iPod/MP Player, or any other electronic devices that can process information automatically. A computing device may have a wired or wireless connection device to connect to one or more databases or to one or more other computing devices. A computing device may be a client computer that communicates with a host computer in a multi-computer client-host system connected via a wired or wireless network including intranet and internet. A computing device can also be configured to be coupled with a data input or output device via wired or wireless connections. A computing device may further be a subunit of another device. Examples of such a subunit can be a processing chip in an imaging device, a spectrophotometer, or a goniospectrophotometer. A computing device can have an intrinsic display device, such as a display screen of a PDA or a laptop computer; or be connected to a display device, such as a monitor screen, or a TV. A “portable computing device” includes a laptop computer, a pocket PC, a personal digital assistant (PDA), a handheld electronic processing device, a mobile phone, a smart phone that combines the functionality of a PDA and a mobile phone, a tablet computer, an iPod, an iPod/MP Player, or any other stand alone or subunit devices that can process information and data and can be carried by a person.

An imaging device refers to a device that can capture images under a wide range of electromagnetic wavelengths including visible or invisible wavelengths. Examples of the imaging device include, but not limited to, a still film optical camera, a digital camera, an X-Ray camera, an infrared camera, an analog video camera, and a digital video camera. A digital imager or digital imaging device refers to an imaging device captures images in digital signals. Examples of the digital imager include, but not limited to, a digital still camera, a digital video camera, a digital scanner, and a charge coupled device (CCD) camera. An imaging device can capture images in black and white, gray scale, or various color levels. A digital imager is preferred in this invention. Images captured using a non-digital imaging device, such as a still photograph, can be converted into digital images using a digital scanner and can also be suitable for this invention. The imaging device can further comprise an illumination device that provided illuminations at a single or multiple angles.

A display device can be a computer monitor, a projector, a TV screen, a personal digital assistant (PDA) device, a cell phone, a smart phone that combines PDA and cell phone, an iPod, an iPod/MP Player, a flexible thin film display, or any other devices that can display information or images based on digital signals. Further examples of display devices include a display screen of a digital camera, a display screen of the aforementioned imaging device, a display screen of a color measuring device, or display screen of an appearance measuring device described below. The display device can also be a printing device that prints, based on digital signals, information or image onto papers, plastics, textiles, or any other surfaces that are suitable for printing the information or images onto. The display device can also be a duel functional display/data input device, such as a touch screen.

The term “repair formula” or “repair data” refers to a collection of information such as formulations, procedures, instructions, or any other information that guides an operator to repair the defect. For repairing a coating defect, the repair data typically comprise a matching coating formula. In one example, a set of repair data comprises a color formulation, a color mixing procedure and a paint application method to match and repair a color coating defect. In another example, another set of repair data comprises an instruction to find an access to the back of a metal dent on a vehicle's body with a specific make and model, a recommendation for tool selection, and a method for moving the dented metal portion to its pre-damage state. In yet another example, a set of repair data comprises an instruction on how to cut out a damaged upholstery, materials needed for repair, a procedure for repair and the time needed for the repair to be set before being touched. In yet another example, a repair instruction comprises instructions, materials, tool recommendations and procedures on how to repair a damaged windshield. A standard repair data may be readily available from one database for some common defects. An operator may use the specification directly without modification. It is possible that more than one set of repair specifications are available. Under this situation, the operator may make a determination on which set to use or may choose to combine more than one sets. The operator may choose to modify a standard repair specification to fit the need of individual repair. In an event that a standard repair specification is not available for the specific defect, an skilled operator may identify a standard repair specification for a similar defect and modify it to provide the best repair.

The term “memory member” or “memory” includes internal memory, random access memory (RAM), internal hard drive, memory card, removable memory card, flash memory card, writable or re-writable compact disk, compact disc Read-Only Memory (CD-ROM), or any other electromagnetic or optical devices that can be used to store and/or retrieve data. Some examples of removable or flash memory cards include USB flash memory, SD memory card, and memory stick.

The term “data input device” includes, but not limited to, a scanner, a barcode reader, an RFID (radio frequency identification device) sensor, a camera, a video camera, a memory card, a memory card reader, a hard drive, a portable hard drive, a disk drive, a compact disk drive, a cell phone, a PDA, a computer, a key board, a hand-writing recognition device, an interactive input-display device, or any other devices that can input data into a computing device or a host computer. The data input device can also include any devices, hardware or software that is necessary for operatively coupling the data input device to a computing device or a host computer.

The term “data output device” includes, but not limited to, a printer, a fax machine, a memory card, a memory card writer, a hard drive, a portable hard drive, a disk drive, a writable compact disk drive, a cell phone, a PDA, a computer, or any other devices that can output data from a computing device or a host computer. The data output member also includes any devices, hardware or software that are necessary for operatively coupling the data output device to a computing device or a host computer.

The term “network device” or “connection device” includes wired or wireless communication devices that enable the computing device to communicate with one or more electronic devices, such as an input device, an output device, or a host computer, through wired or wireless connections. “Wired communication devices” or “wired connections” include hardware couplings, splitters, connectors, cables or wires. “Wireless communication devices” or “wireless connections and devices” include, but not limited to, Wi-Fi device, Bluetooth device, wide area network (WAN) wireless device, Wi-Max device, local area network (LAN) device, 3G broadband device, infrared communication device, optical data transfer device, radio transmitter and optionally receiver, wireless phone, wireless phone adaptor card, or any other devices that can transmit signals in a wide range of electromagnetic wavelengths including radio frequency, microwave frequency, visible or invisible wavelengths. The network device can also provide wired or wireless connections to couple one or more data input or data output devices to the computing device.

The term “cost data” or “repair cost data” for repairing a defect includes actual costs on materials and labors, and profits that a repair shop earns. The cost data can also include taxes, database subscription fees, regulatory fees, such as waste disposal fees, or other fees and charges incurred for repairing the defect. Multiple levels of the cost data can be displayed based on different configurations of the embodiments of this invention. In one embodiment, the cost data is displayed as two separate cost items: 1) a sum of costs reflecting the actual costs of repair materials, labor and profits; and 2) taxes and regulatory fees and other fees and charges such as store space rental fees or local property taxes. In another embodiment, cost data is displayed as a single item that is a sum of actual costs on materials and labors, profits, taxes, regulatory fees and other fees and charges as mentioned above. In yet another embodiment, the cost data is displayed as only the actual costs of repair materials and labor, taxes, regulatory fess and other fees and charges as mentioned above.

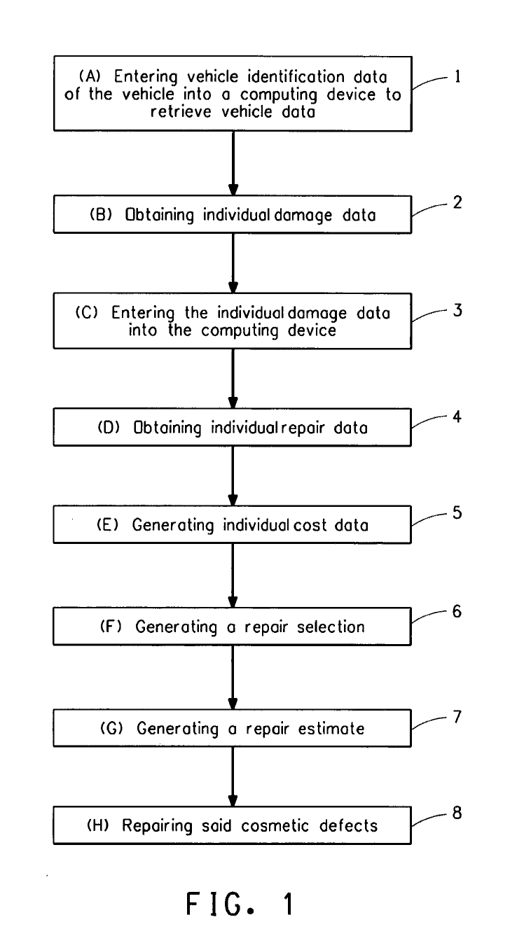

This invention is directed to a method for repairing one or more cosmetic defects of a vehicle of a customer. A representative flow chart of the method is shown in FIG. 1. In one embodiment, said method comprises the following steps:

(A) entering vehicle identification data of the vehicle into a computing device (1) to retrieve vehicle data from a vehicle database accessible from the computing device based on the vehicle identification data;

(B) obtaining individual damage data of said cosmetic defects (2);

(C) entering the individual damage data into the computing device (3);

(D) obtaining individual repair data (4) from the computing device based on the individual damage data and the vehicle data;

(E) generating individual cost data (5) from the computing device based on the individual damage data and the individual repair data;

(F) generating a repair selection (6) by specifying whether each of said defects is to be repaired;

(G) generating a repair estimate (7) from the computing device based on the individual damage data, the individual cost data and the repair selection; and

(H) repairing said cosmetic defects (8) based on the repair data and the repair selection.

Vehicle identification data can be selected from a vehicle identification number (VIN) of the vehicle, part of the VIN, a manufacturer of the vehicle, a manufacturer plant site of the vehicle, model and model year of the vehicle, paint color code, or a combination thereof. In most countries today, VINs are required by law. For example, the U.S. government currently requires all cars and trucks made for sale in U.S. to carry a 17-character vehicle identification number, which is made up of a combination of 17 numbers and letters. Each position in the VIN (numbered from left to right) is assigned a certain meaning which is applicable to all vehicle manufacturers, all of which is public information (Federal Register, Vol. 61, No. 111, Rules and Regulations, Page 29031-29036, Jun. 7, 1996). Once one obtains the meaning for each position and each character, the VIN code can be broken or parsed and key facts about a vehicle can be obtained. In the standardized 17-character format, the first 11 characters define particular features of the vehicle, while the last 6 characters identify the production sequence of that vehicle. Within the first 11 characters, the 10th and 11th characters, in particular, are used to identify the vehicle's model year and site of manufacture, respectively. Vehicle engine type, vehicle body style and retrain system type are identified by characters at 4th to 8th positions. Part of the VIN, such as the first 11 characters, can be used as vehicle identification data in this invention. In another example, the 10th and 11th characters of the VIN and the paint color code can be used as vehicle identification data. In yet another example, the last 6 characters identifying the production sequence of that vehicle, also known as “product sequence”, can be used as part of the vehicle identification data to retrieve color data.

Vehicle data can be retrieved from a vehicle database based on the vehicle identification data. Vehicle data used herein can include manufacturing information such as make, model, model year, vehicle body style, site of manufacture, production sequence, and other information of the vehicle that are provided by a vehicle manufacturer, which can be retrieved based on the VIN. The vehicle data can also include other data, such as refinish coating formulations, instructions on repair process and materials that are developed by vehicle manufacturers, refinish coating providers, or vehicle parts suppliers. For example, some coating providers have developed vehicle refinish coating formulations for repairing vehicle coating defects and those coating formulations can be retrieved based on the VIN or a part of the VIN.

The vehicle data can further include a diagram of a vehicle specific to vehicle body style that can be identified based on the VIN. The vehicle diagram can be retrieved from a diagram database based on the vehicle body style identified by the VIN. The diagram database can be part of the vehicle database. The vehicle diagram can also be generated dynamically based on vehicle body style identified by the VIN by a computing device and stored in a temporary database. For example, if the VIN indicates that vehicle body style of the vehicle for repair is a sedan, then a diagram of a sedan can be retrieved as part of the vehicle data. The diagram database containing vehicle diagrams including the temporary database can be operatively residing in a computing device used for this invention or in other computer or computing device, such as a host computer operatively communicating with the computing device. The diagram database containing vehicle diagrams can also be part of another database, such as the aforementioned vehicle database. In one example, a vehicle diagram is retrieved from a database residing in a portable computing device based on vehicle body style identified by the VIN. In another example, a vehicle diagram is retrieved from a database residing in a host computer based on the vehicle body style identified by the VIN. In a preferred embodiment, the vehicle identification data comprise VIN and paint color code of a vehicle, wherein vehicle data such as manufacturer of the vehicle, manufacturer plant site of the vehicle, model and model year of the vehicle, and body style of the vehicle, can be retrieved based on the VIN from the vehicle database. It is understood, that the vehicle database can comprise additional information about the vehicle that are provided by the vehicle manufacturer or refinish or aftermarket vendors. It is preferred that said vehicle database comprises vehicle data that can be retrieved by VIN or part of VIN. Commercial vehicle databases readily available from vehicle manufacturers or vehicle refinish companies are suitable for this invention. One example of such vehicle database is described in published European patent application EP 1139234.

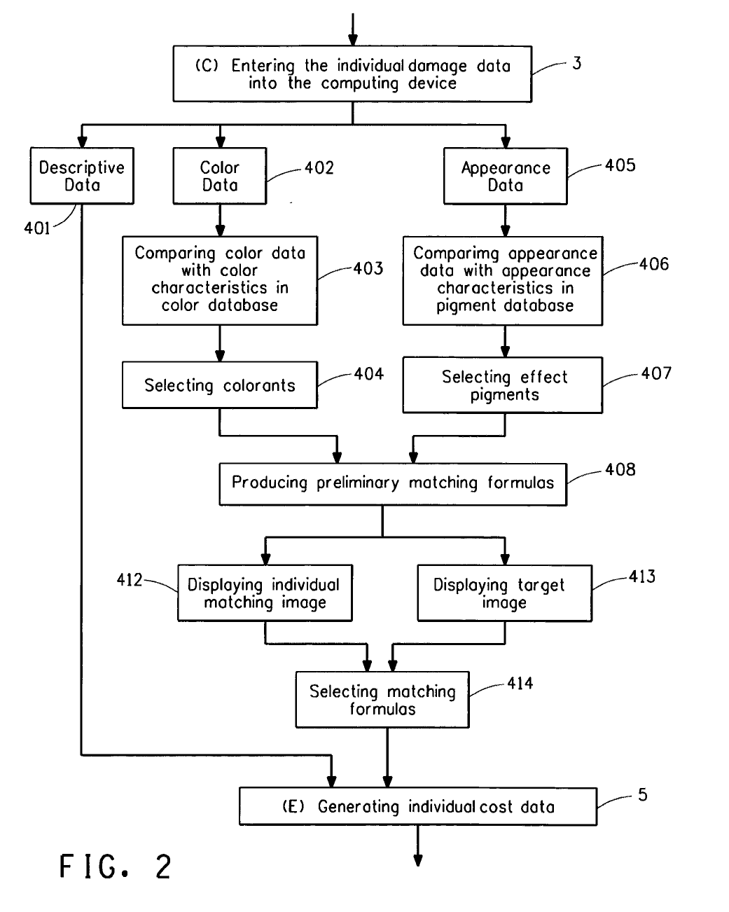

The term “damage data” used herein includes descriptive data (401, FIGS. 2, 3, 4 and 5) such as a description or category, severity, location, size and other data that provide description of a defect. For a coating defect, the damage data can also include color data (402) or appearance data (405), or both the color and the appearance data of the coating where the defect is located or adjacent to. Damage dada for individual defect is referred to as “individual damage data”. Individual damage data can be obtained by visual inspection or by instrumental measurement of the defect or adjacent areas of the defect. For a coating defect of a vehicle, the color data and optionally the appearance data can usually be obtained by measuring an adjacent area of the coating defect that is covered with an original coating, such as an OEM coating.

The color data (402) can be obtained from a color measuring device, or retrieved from a color database based on the vehicle data such as the VIN and the paint color code of a vehicle. The color data can also be retrieved based on both the color measurement device and the vehicle data such as the VIN and paint color code. Typically, the color characteristics can comprise L,a,b, or L*,a*,b*, or X,Y,Z values known to those skilled in the art and can be obtained by using a color measuring device such as a colorimeter, a spectrophotometer, or a goniospectrophotometer.

The appearance data (405) can be obtained from an appearance measuring device or retrieved from an appearance database based the vehicle data such as the VIN and the paint color code of a vehicle. The appearance data can also be retrieved based on both the appearance measurement device and the vehicle data such as the VIN and the paint color code. The appearance measuring device of this invention can comprise an imaging device wherein the appearance data are derived from images of the coating. Methods described in U.S. Pat. No. 6,952,265, or U.S. Pat. No. 6,975,404, can be useful for this invention.

Appearance data can include, but not limited to, visual texture, metallic, pearlescent effect, gloss, distinctness of image, flake appearances such as sparkle, glint and glitter as well as the enhancement of depth perception in the coatings imparted by the flakes, especially produced by metallic flakes, such as aluminum flakes.

Color and appearance data may contain one or more illumination angels or view angles. Color and appearance data can be in the form of electronic data files that are readable by a computing device.

Repair data can be obtaining based on the vehicle data and the damage data. For example, if a defect is a small cut in vehicle interior upholstery, the repair data comprising instructions on repair process and materials needed for repair can be retrieved from a repair database that can be part of the vehicle database. If a defect is a coating defect, the repair data typically comprise one or more matching formulas for producing a matching coating composition that can be used to repair said coating defect. It is desired that repaired coating defect has good color and appearance matching the original coating, such as the OEM coating, so the repaired coating defect is not noticeable by human eyes.

A number of processes can be used to produce such matching formulas. Some examples are described below.

In one example shown in FIG. 2, the one or more matching formulas are obtained by a process comprising the steps of:

(i) comparing (406) the appearance data (405) with appearance characteristics of known effect pigments stored in an effect pigments database;

(ii) selecting (407) from said effect pigments database, one or more matching effect pigments, effect pigments combinations or effect pigments ratios that have appearance characteristics matching said appearance data;

(iii) comparing (403) said color data (402) with color characteristics of one or more colorant combinations of known colorants stored in a colorant database to select from said colorant database, one or more colorant combinations (404) that have color characteristics matching said color data;

(iv) determining colorant concentrations of each said known colorant of said colorant combinations and said effect pigments concentrations of each of the match effect pigments, the effect pigments combinations or the effect pigments ratios;

(v) producing (408) one or more preliminary refinish matching formulas according to said colorant concentrations and said effect pigments concentrations, wherein match coatings resulted from said matching formulas have color characteristics matching the color data and appearance characteristics matching the appearance data;

(vi) generating and displaying matching images (412) based on said preliminary matching refinish formulas;

(vii) optionally, generating and displaying one or more target images (413) based on said color data and said appearance data, or based on the vehicle data and the appearance data; and

(viii) selecting said one or more matching formulas (414) from said preliminary matching refinish formulas by comparing said matching images and the coating of the vehicle, or by comparing said matching images and said target images.

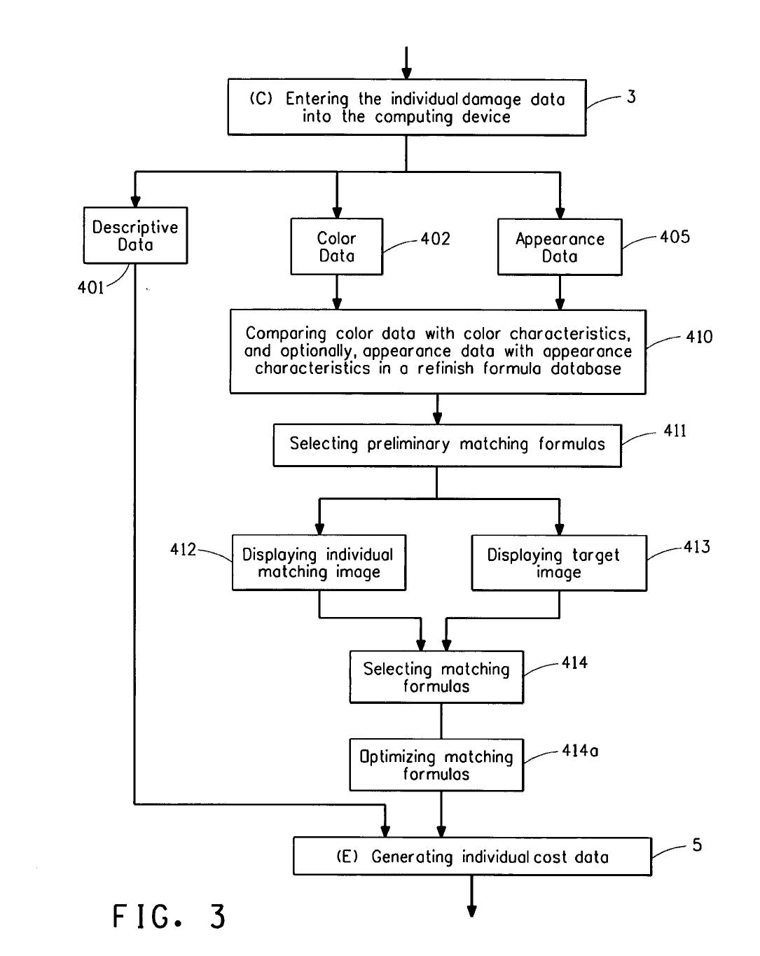

In another example shown in FIG. 3, said one or more matching formulas are obtained by a process comprising the steps of:

(i) comparing (410) said color data (402) with color characteristics of known refinish formulas in a refinish formula database comprising interrelated refinish formulas, identification data of vehicles, color characteristics, and optionally appearance characteristics;

(ii) comparing (410) the appearance data with appearance characteristics of known refinish formulas in the refinish formula database if the coating comprises effect pigments;

(iii) selecting (411) from said refinish formula database, one or more preliminary matching refinish formulas that have color characteristics matching said color data and optionally, appearance characteristics matching said appearance data; and

(iv) generating and displaying (412) matching images based on said preliminary matching refinish formulas;

(v) optionally, generating and displaying (413) one or more target images based on said color data and said appearance data, the vehicle identification data and the appearance data, or the vehicle identification data and the color data;

(vi) selecting (414) said one or more matching formulas from said preliminary matching refinish formulas by comparing said matching images and the coating of the vehicle, or by comparing said matching images and said target images.

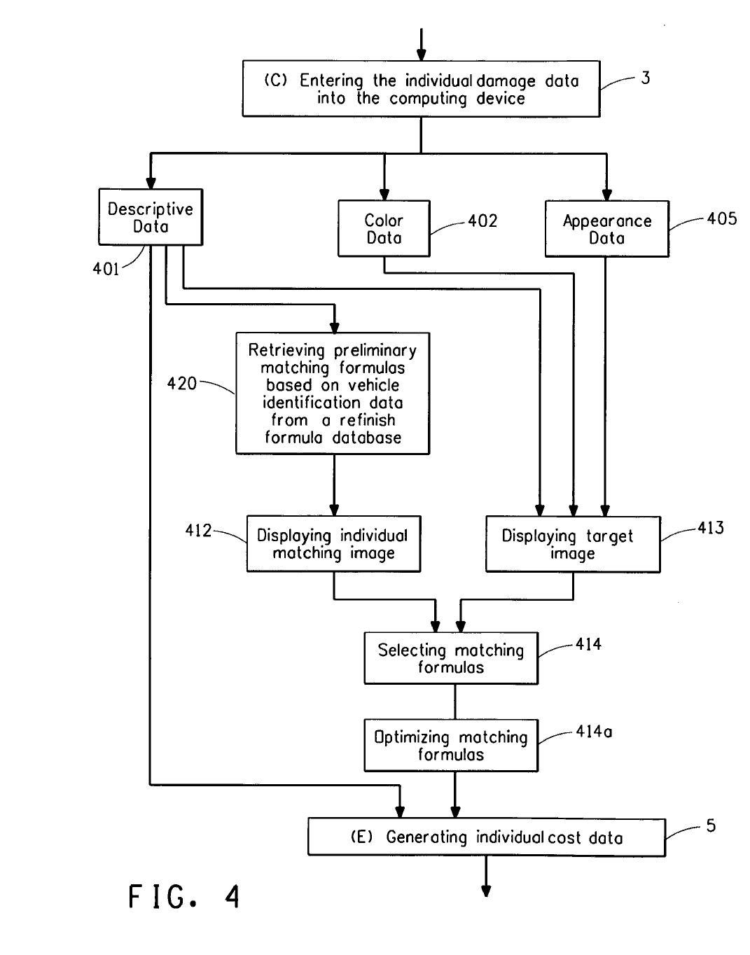

In yet another example shown in FIG. 4, said one or more matching formulas are obtained by a process comprising the steps of:

(i) retrieving (420)one or more preliminary matching formulas from a refinish formula database that match the vehicle identification data, said refinish formula database comprises interrelated refinish formulas, identification data of vehicles, color characteristics, and optionally appearance characteristics;

(iv) generating and displaying (412) matching images based on said preliminary matching refinish formulas;

(v) optionally, generating and displaying (413) one or more target images based on said color data and said appearance data, the vehicle identification data and the appearance data; or the vehicle identification data and the color data; and

(vi) selecting (414) said one or more matching formulas from said preliminary matching refinish formulas by comparing said matching images and the coating of the vehicle, or by comparing said matching images and said target images.

In the examples described above, each of said matching image or said target image can be displayed as a realistic image. Methods for generating realistic images of a coating based on coating formulas and color and appearance characteristics are described in commonly owned U.S. patent application Ser. No. 11/588471, filed on Oct. 27, 2006, and U.S. patent application Ser. No. 11/731569, filed on Mar. 29, 2007, which are incorporated by reference in their entirety. In brief, the images are generated by converting the L,a,b, or L*,a*,b*, values at at least three angles to corresponding XYZ values, calculating a range of aspecular angles required for display, and calculating corresponding R, G, B values from the corresponding XYZ values and the angles for display. The R, G, B values may further be modified or calibrated to fit various display devices.

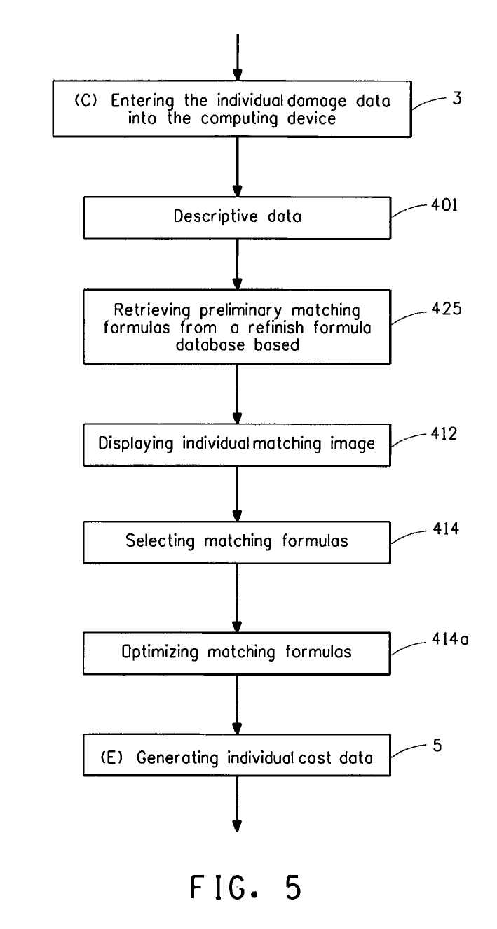

In yet another example shown in FIG. 5, said one or more matching formulas can be obtained based on the vehicle identification data such as the VIN and the paint color code without the need for color data or appearance data from measurement instruments. Details on retrieving formulas based on the VIN and the paint color code are described in published European patent application EP 1139234. In brief, paint color code and manufacturing information extracted from the VIN are used as descriptive data to retrieve (425) one or more preliminary matching formulas from a refinish formula database that match the vehicle identification data, said refinish formula database comprises interrelated refinish formulas, identification data of vehicles, color characteristics, and optionally appearance characteristics. In this invention, individual matching images are generated based on the color characteristics, and optionally the appearance characteristics, interrelated to each of the preliminary matching formulas; and displayed (412). One or more matching formulas can be selected (414) from said preliminary matching refinish formulas by comparing said matching images and the coating of the vehicle. Each of said matching images can also be displayed as a realistic image that shows color variations at different illumination or viewing angles.

The selected matching formulas can be further optimized (414a, FIGS. 3, 4 and 5) based on human color tolerance or perception, metamerism indices, color and appearance under different illumination or viewing angles, or material availability that are known to those skilled in the art.

Methods for selecting and optimizing matching formulas described in U.S. Pat. No. 7,145,656, U.S. Pat. No. 6,952,265, and U.S. Patent Application No. 20060181707 can be suitable for this invention.

Once the repair data is obtained, cost data can be generated (5) based on the damage data and the repair data. For example, cost data can be calculated by the computing device based size of the coating defect specified in the damage data and amounts of materials, such as pigments or effect pigments needed to match the color and the appearance, as specified in matching formulas. The repair data can also specify the number coating layers that are needed to achieve desired match. The cost data can be generated accordingly based such specifications. Those who skilled in the art can readily program the computing device to calculate and generate the cost data based on the damage data and the repair data.

It is common that the customer may want to want to make a decision on whether or not to repair some or all of the defects. One major factor affecting that decision is the cost for repair. One advantage of this invention is that the more accurate cost data can be generated based. The cost data can be shown to the customer, for example the owner of the vehicle or a representative of an insurance company who provides insurance coverage for the repair cost, in a number of ways. In one example, the repair cost is displayed on a computer screen or a PDA screen. In another example, the cost is printed on a piece of paper. In yet another example, the cost is sent to the customer by e-mail, fax, text messaging, instant messaging, or regular mail. It is preferred that the cost data is shown to the customer on the screen of a portable computing device, such as an interactive touch screen of a pocket PC.

The cost data can also be shown to the customer in a repair selection (6). The repair selection can be a list of defects that have repair data and cost data associated with. Such repair selection can also show an identifier of each of the defects and cost for repair each of said defects. The repair selection can be generated by the computing device based on processes well known to those skilled in the art. The customer or the repair technician can make a decision on which defects is to be repaired and input the selection into a computing device or an input device functionally coupled to the computing device. For example, if the repair selection is shown on a touch screen of a PDA, the customer or the repair technician can tap the touch screen at predefined areas to make the selection on which of the defects are to be repaired and input the selection into the PDA.

A repair estimate can be then generated (7) based on the individual damage data, individual repair data and the repair selection. The repair estimate is typically generated by adding all the repair costs together for all the defects selected for repair. The term “repair estimate” used herein can include damage data, individual cost data for each of said defects, repair selection, and a total cost for repairing the selected defects based on the repair selection. A repair estimate may include additional items such as, a damage number that is generated by the computing device to identify each defect. It is understood that additional costs or charges can be integrated into the repair estimate. Examples of those costs and charges include, but not limited to, taxes; waste disposal fees; communication charges, such as data transmission fees; subscription fees, such as database subscription fees; or any other fees or charges that are commonly associated with repair. If a repair time is scheduled, the repair estimate may further include the scheduled repair time. A repair estimate may even further optionally include data of the customer. A repair estimate may yet further include optional comments and requests, such as notes to a repair technician regarding the location where the vehicle is parked or a request from the customer for transportation.

The repair estimate can be shown to the customer in a variety of ways as described before, such as on a screen or on a piece of paper. Typically, the customer is required to provide authorization for the repair. The authorization can be verbal approval, electronic signature or physical signature on paper. The customer can also provide a pre-authorization for the repair.

The defect selected for repair can then be repaired (8) based on the repair selection and the repair data. For example, one of a plurality of coating defects can be selected to be repaired. The repair can be done using one of the matching formulas according to conventional coating repair process known to those skilled in the art, such as mixing a matching coating composition according to the matching formula, cleaning the area of the coating defect, priming or sanding, spray coating with the matching coating composition, curing, buffing and polishing.

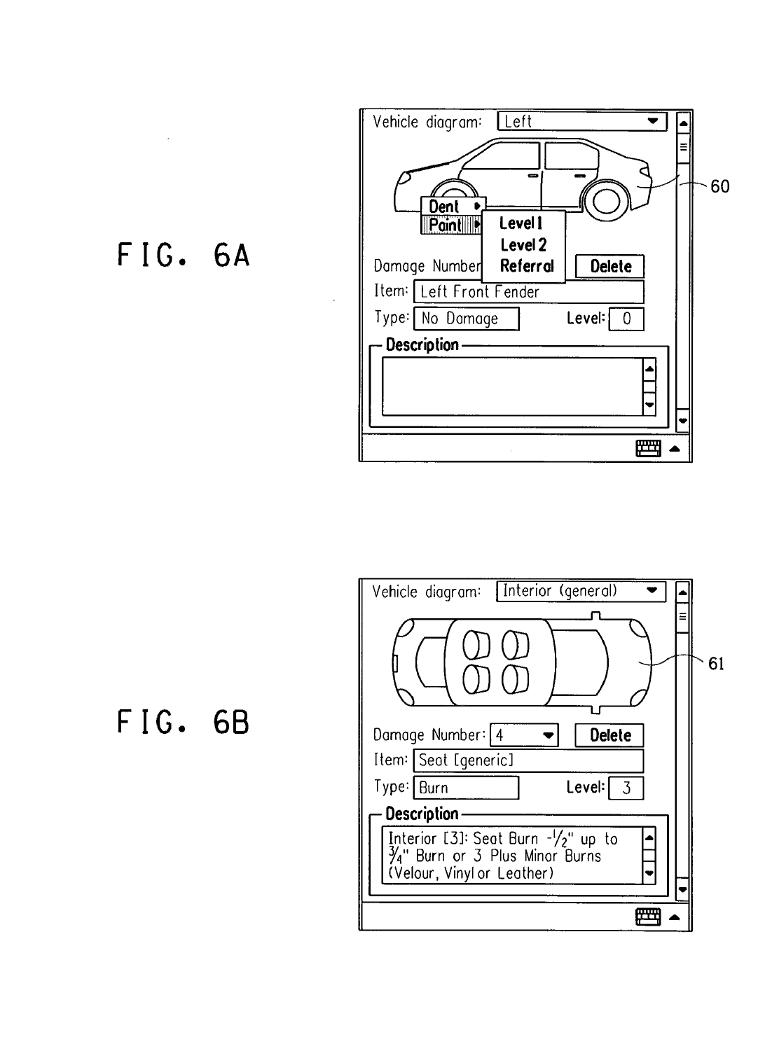

In one example, a car has a plurality of damages and defects. A repair technician uses the VIN of the car to retrieve vehicle data about the car, such as make, model, manufacturing year, manufacturing plant site, and car body style. A diagram of the car can be obtained for documenting locations and other descriptions of those defects and damages. One diagram can be an exterior diagram representing the body style, such as the one shown in FIG. 6A (60). Descriptive data on the damage of the coating, such size of the defect; severity of the defect; type of the defect, such as a dent or paint damage; can be entered into the portable computing device by tapping the corresponding areas of the diagram. The diagram can also be an interior diagram representing the interior layout of the car, such as shown in FIG. 6B (61). In one example, damages on seat fabric can be recorded and entered into the portable computing device by tapping in appropriate areas in the diagram (61).

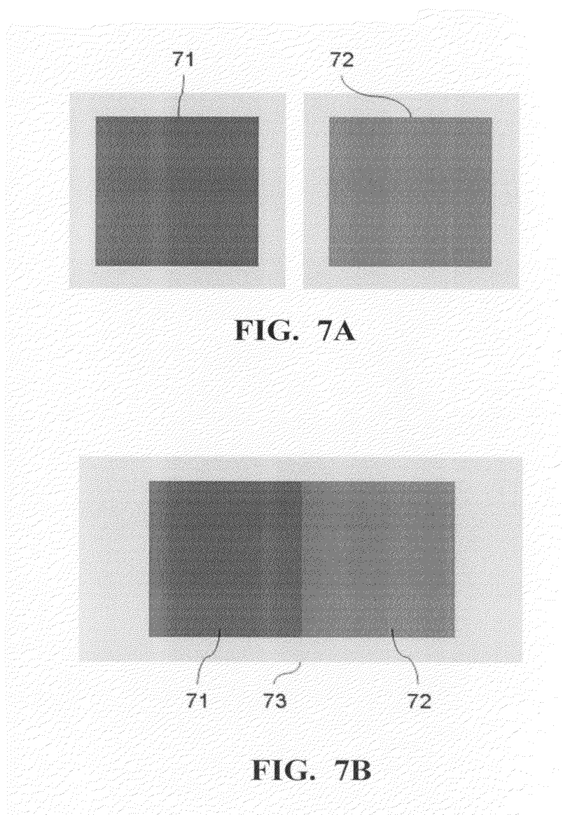

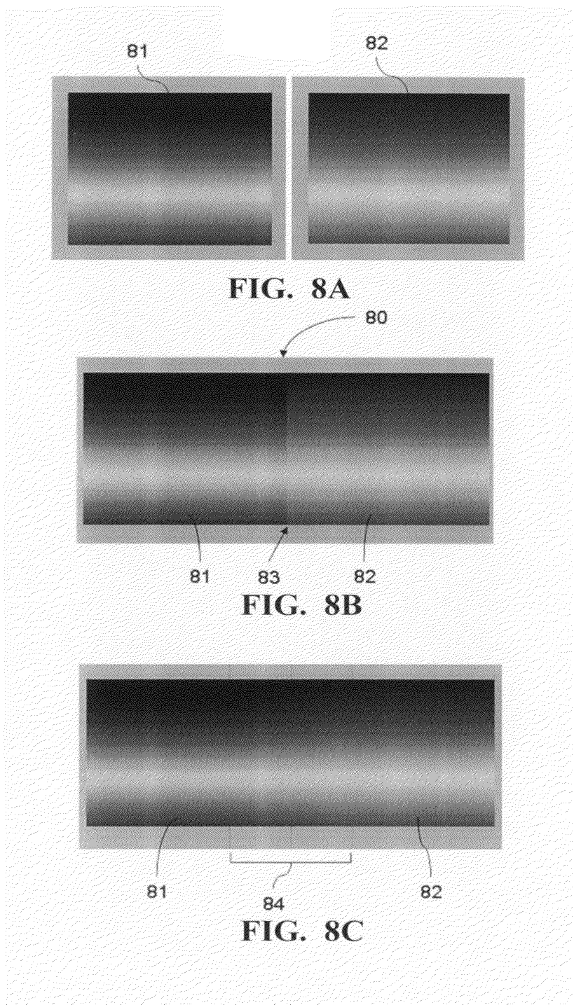

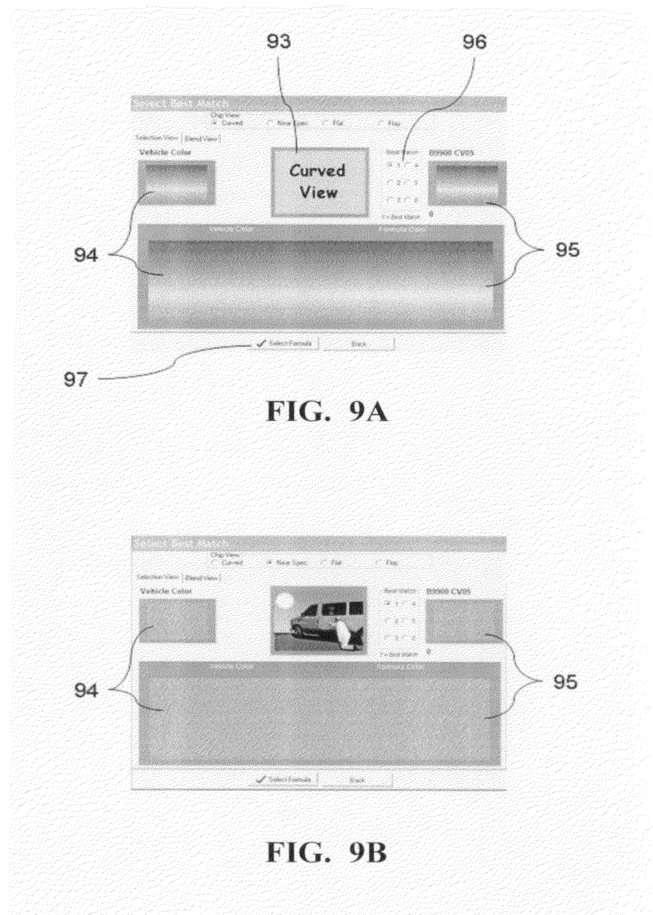

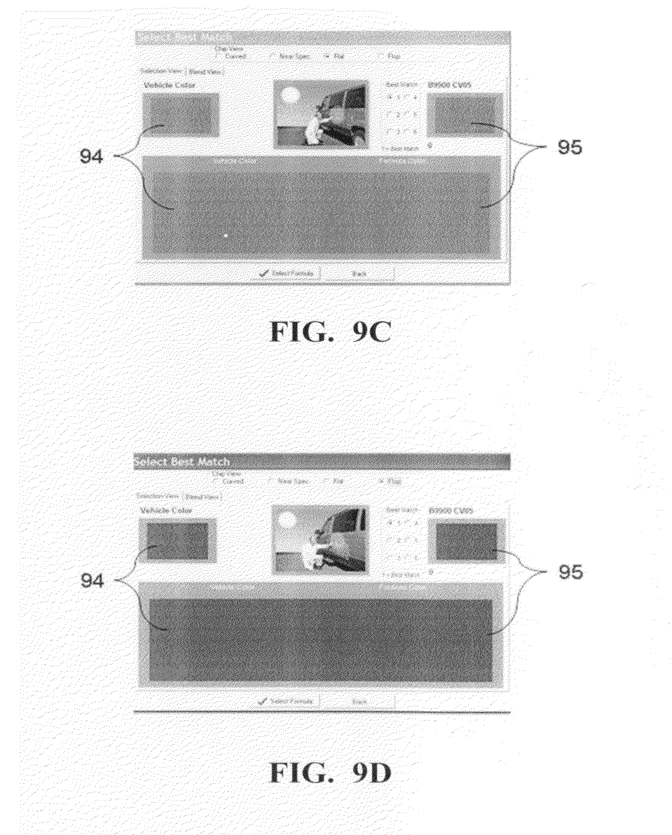

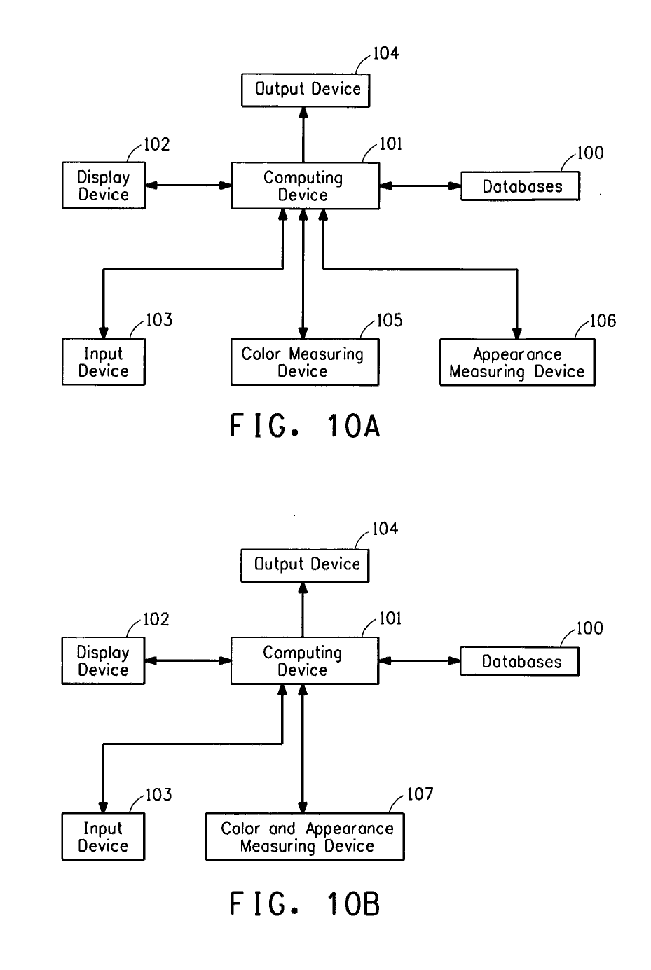

Images of the coating of the vehicle, hereafter referred to as target images, and images based on matching formulas, hereafter referred to as matching images, can be generated and displayed. The target images and the matching images can also be generated and displayed as realistic target images and realistic matching images, respectively, to reflect different view angles or illumination angles. Methods for generating target images, matching images, realistic target images and realistic matching images are described in aforementioned and commonly owned U.S. patent application Ser. No. 11/588471, filed on Oct. 27, 2006, and U.S. patent application Ser. No. 11/731569, filed on Mar. 29, 2007. In one example, target images and matching images for solid colors can be generated and displayed. A target image (71) and a matching image (72) can be displayed side-by-side close to each other on a display device, such as a screen of a PDA, pocket PC, a desktop computer, a laptop computer or a display screen of a color measurement device. The images can also be displayed immediately adjacent to each other so that the target image can have common boarders (73) with one or more matching images, such as shown in FIG. 7B. Various display arrangements or configurations for displaying the target and the matching images are described in aforementioned and commonly owned U.S. patent application Ser. No. 11/731569. In FIG. 8, examples of realistic images can be displayed. A curved view of the target image (81) and a curved view of the matching image (82) can be displayed close to each other (FIG. 8A), or immediately adjacent to each other so the two images share a common boarder (83) in a typical display configuration (80) (FIG. 8B). The realistic target image and the realistic matching image can also be blended into each other in an blending area (84) (FIG. 8C). Additional examples of screenshots for displaying target and matching images are shown in FIGS. 9A-9D, wherein target images (94) and matching images (95) can be displayed in single or multiple viewing angles, single or multiple illumination angles, or as blended images. Additional functions, such as indication of how each image is displayed (93), ranking of the matching formulas (96), and selection of formulas (97) are also shown in FIG. 9.

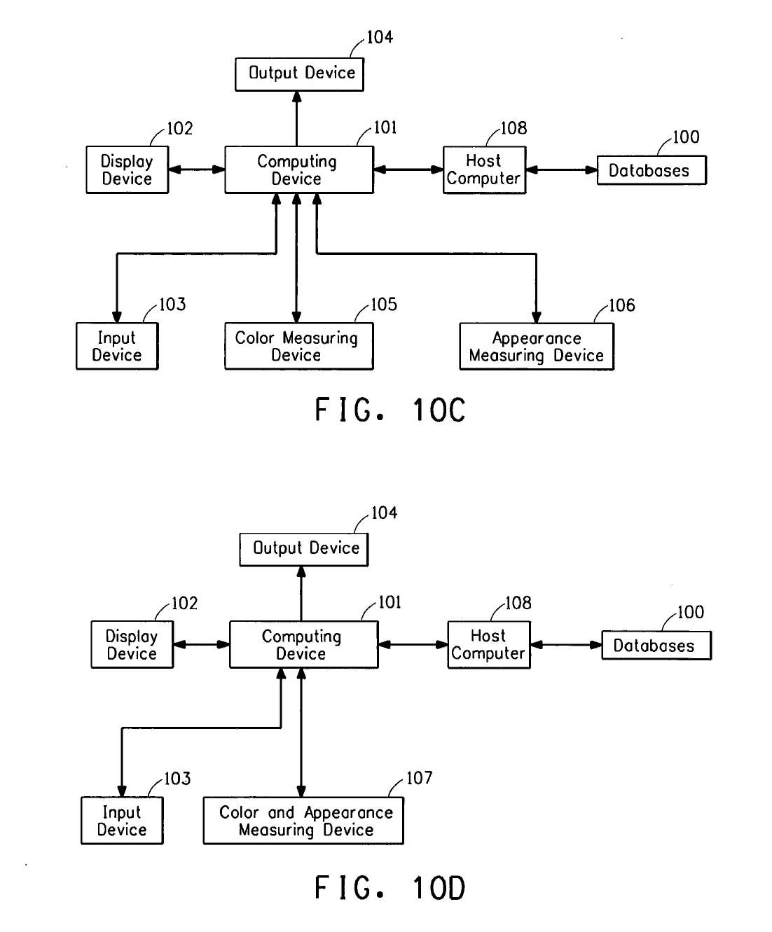

This invention is also directed to a system for repairing one or more cosmetic defects of a vehicle of a customer. In a representative example, said system comprises (FIG. 10A):

(A) a computing device (101) comprising a memory member;

(B) at least one data input device (103) and at least one data output device (104), wherein said data input and output devices are functionally coupled to said computing device;

(C) at least one display device (102) functionally coupled to said computing device;

(D) one or more databases (100) accessible from said computing device;

(E) a color measuring device (105), and optionally, an appearance measuring device (106); and

(F) a computing program product operatively residing in said memory member that causes the computing device to perform a computing process comprising the steps of:
(1) receiving vehicle identification data of the vehicle from the data input device;
(2) retrieving vehicle data from a vehicle database accessible from the computing device based on the vehicle identification data;
(3) receiving individual damage data of said cosmetic defects;
(4) generating individual repair data based on the individual damage data and the vehicle data;
(5) retrieving individual cost data based on the individual damage data and the individual repair data;
(6) generating a repair selection by displaying a repair selection question and receiving repair selection input to said repair selection question specifying whether each of said defects is to be repaired;
(7) generating a repair estimate based on the individual damage data, the individual cost data and the repair selection;
(8) optionally, generating a repair schedule for repairing at least one defect specified in the repair selection; and
(9) outputting the repair data, the repair estimate, or a combination thereof.

The system can have different hardware configurations. For example, the color measuring device and the appearance measuring device can be configured into a single device (107) (FIG. 10B and D). The computing device can be connected to a host computer (108) through wired or wireless connections (FIGS. 10C and D). Some or all databases can be residing in the computing device, the host computer, or a combination thereof. The color measuring device (105), the appearance measuring device (106) or the combined color/appearance measuring device (107) can comprise a separate display device or share a display device with the computing device. Any of aforementioned data input or data output devices can be suitable for the system of this invention. The data input or the data output devices can be coupled to the computing device through wired or wireless connections. The data input or the data output devices, the color measuring device or the appearance measuring device can further have additional display devices, such as a display screen; a memory device, such as a memory chip; additional input or output devices. For example, when a barcode scanner is used as an input device to read a vehicle identification number, the barcode scanner itself can have a display device such as touch screen; one or more input device, such as an optical sensor, a key pad, or the touch screen; and an output device such as one or more wired or wireless connection devices for connecting to a printer or a computer.

The computing device and said color measuring device, and optionally the appearance measuring device, can be integrated as one portable device.

The system can further comprise an illumination device that can provide illumination at a single or multiple angles.

In one example, the system comprises a set of databases, such as a Vehicle database, a Color database, a Colorant database, an appearance database, an effect pigment database, a Refinish formula database, a Cost database, and a Scheduling database. It is preferred that one or more common information element, such as the VIN, can be used to interrelate data in the databases. The system can further have additional databases, such as a database to store optimized matching formulas optimized based on human color tolerance or perception, metamerism indices, color and appearance under different illumination or viewing angles, or material availability as described before. Such optimized matching formulas can later be interrelated to some identification data such as a VIN and integrated into the Refinish formula database if so desired. Other examples of additional database can include a financial database comprising financial income and payment data of the vehicle repairs; a customer database comprising customer information, such as contact address, and vehicle history; and a supplier database comprising information on repair material suppliers.

Although vehicle and vehicle coating are specifically described, this invention can also be used for repairing other articles wherein the articles can be identified by article identification information, such as catalog numbers or color codes. Some examples of such articles include, but not limited to: home appliances, such as refrigerator, washing machine, dishwasher, microwave ovens, cooking and baking ovens; electronic appliances, such as television sets, computers, electronic game sets, audio and video equipments; recreational equipments, such as bicycles, ski equipments, all terrain vehicles; and home or office furniture, such as tables, file cabinets. Other examples of the articles include, but not limited to, engineering polymers, injection molding plastics or polymers, or other synthetic materials such as Cohan® available from DuPont, wherein Corian® is a registered trademark of DuPont. Repair data can include matching formulas for repairing one or more coating defects of the article, repair instructions for repairing dents of the article body, repair instructions for repairing small damages of the article body or body parts, or a combination thereof. Repair data can also include repair matching formulas for repair damages to plastic or polymer parts of the article so color and appearance of the parts can be matched. For example, the repair data can include one or more matching formulas to match color and appearance of an article made from Corian®. Color data and optionally appearance data can be obtained by visual inspection or by using a color measuring device, and optionally by using an appearance measuring device. Selection of matching formulas for repairing the articles can be performed according to the method of this invention.

1. A method for repairing one or more cosmetic defects of a vehicle of a customer, said method comprising the steps of:
(A) entering vehicle identification data of the vehicle into a computing device to retrieve vehicle data from a vehicle database accessible from the computing device based on the vehicle identification data;
(B) obtaining individual damage data of said cosmetic defects;
(C) entering the individual damage data into the computing device;
(D) obtaining individual repair data from the computing device based on the individual damage data and the vehicle data;
(E) generating individual cost data from the computing device based on the individual damage data and the individual repair data;
(F) generating a repair selection by specifying whether each of said defects is to be repaired;
(G) generating a repair estimate from the computing device based on the individual damage data, the individual cost data and the repair selection; and
(H) repairing said cosmetic defects based on the repair data and the repair selection.

2. The method of claim 1, wherein said vehicle identification data are selected from a vehicle identification number (VIN) of the vehicle, part of the VIN, a manufacturer of the vehicle, a manufacturer plant site of the vehicle, model and model year of the vehicle, paint color code, or a combination thereof.

3. The method of claim 2, wherein at least one of said cosmetic defects is a coating defect of the vehicle and wherein said individual repair data comprises one or more matching formulas for repairing said coating defect.

4. The method of claim 3, wherein the individual damage data of said coating defect is obtained by a process comprises the steps of (1) obtaining color data of the coating of the vehicle; and (2) optionally, obtaining appearance data of the coating of the vehicle.

5. The method of claim 4, wherein the color data is obtained from a color measuring device, retrieved from a color database based on the vehicle data, or a combination thereof.

6. The method of claim 4, wherein the appearance data is obtained from an appearance measuring device, retrieved from an appearance database based the vehicle data, or a combination thereof.

7. The method of claim 3, wherein said one or more matching formulas are obtained by a process comprising the steps of:
(i) comparing the appearance data with appearance characteristics of known effect pigments stored in an effect pigments database;
(ii) selecting from said effect pigments database, one or more matching effect pigments, effect pigments combinations or effect pigments ratios that have appearance characteristics matching said appearance data;
(iii) comparing said color data with color characteristics of one or more colorant combinations of known colorants stored in a colorant database to select from said colorant database, one or more colorant combinations that have color characteristics matching said color data;
(iv) determining colorant concentrations of each said known colorant of said colorant combinations and said effect pigments concentrations of each of the match effect pigments, the effect pigments combinations or the effect pigments ratios;
(v) producing one or more preliminary refinish matching formulas according to said colorant concentrations and said effect pigments concentrations, wherein match coatings resulted from said matching formulas have color characteristics matching the color data and appearance characteristics matching the appearance data;
(vi) generating and displaying matching images based on said preliminary matching refinish formulas;
(vii) optionally, generating and displaying one or more target images based on said color data and said appearance data, or based on the vehicle data and the appearance data; and
(viii) selecting said one or more matching formulas from said preliminary matching refinish formulas by comparing said matching images and the coating of the vehicle, or by comparing said matching images and said target images.

8. The method of claim 3, wherein said one or more matching formulas are obtained by a process comprising the steps of:
(i) comparing said color data with color characteristics of known refinish formulas in a refinish formula database comprising interrelated refinish formulas, identification data of vehicles, color characteristics, and optionally appearance characteristics;
(ii) comparing the appearance data with appearance characteristics of known refinish formulas in the refinish formula database if the coating comprises effect pigments;
(iii) selecting from said refinish formula database, one or more preliminary matching refinish formulas that have color characteristics matching said color data and optionally, appearance characteristics matching said appearance data; and
(iv) generating and displaying matching images based on said preliminary matching refinish formulas;
(v) optionally, generating and displaying one or more target images based on said color data and said appearance data, the vehicle identification data and the appearance data, or the vehicle identification data and the color data;
(vi) selecting said one or more matching formulas from said preliminary matching refinish formulas by comparing said matching images and the coating of the vehicle, or by comparing said matching images and said target images.

9. The method of claim 3, wherein said one or more matching formulas are obtained by a process comprising the steps of:
(i) retrieving one or more preliminary matching formulas from a refinish formula database that match the vehicle identification data, said refinish formula database comprises interrelated refinish formulas, identification data of vehicles, color characteristics, and optionally appearance characteristics;
(ii) generating and displaying matching images based on said preliminary matching refinish formulas;
(iii) optionally, generating and displaying one or more target images based on said color data and said appearance data, the vehicle identification data and the appearance data, or the vehicle identification data and the color data; and
(iv) selecting said one or more matching formulas from said preliminary matching refinish formulas by comparing said matching images and the coating of the vehicle, or by comparing said matching images and said target images.

10. The method of claim 7, 8 or 9, wherein each of said matching images or said target images is displayed as a realistic image.

11. The method of claim 3, wherein said vehicle identification data comprises the paint color code and manufacturing information extracted from the VIN, wherein said manufacturing information is selected from make, model, model year, site of manufacture, production sequence of the vehicle, or a combination thereof, wherein said one or more matching formulas are obtained by a process comprising the steps of:
(i) retrieving one or more preliminary matching formulas from a refinish formula database that match the vehicle identification data, said refinish formula database comprises interrelated refinish formulas, identification data of vehicles, color characteristics, and optionally appearance characteristics;
(ii) generating and displaying individual matching images based on the color characteristics, and optionally the appearance characteristics, interrelated to each of the preliminary matching formulas; and
(iii) selecting said one or more matching formulas from said preliminary matching refinish formulas by comparing said matching images and the coating of the vehicle.

12. The method of claim 1 further comprising the steps of:
(I) scheduling a repair time for repairing at least one defect specified in the repair selection;
(J) optionally, entering data of the customer into said computing device; and
(K) optionally, optimizing said one or more matching formulas.

13. A method for repairing one or more cosmetic defects of an article of a customer, said method comprising the steps of:
(A) entering article identification data of the article into a computing device;
(B) obtaining individual damage data of said cosmetic defects;
(C) entering the individual damage data into the computing device;
(D) obtaining individual repair data from an article database accessible from the computing device based on the individual damage data and the article identification data;
(E) generating individual cost data from the computing device based on the individual damage data and the individual repair data;
(F) generating a repair selection by specifying whether each of said defects is to be repaired;
(G) generating a repair estimate from the computing device based on the individual damage data, the individual cost data and the repair selection; and
(H) repairing said cosmetic defects based on the repair data and the repair selection.

14. A system for repairing one or more cosmetic defects of a vehicle of a customer, said system comprising:
(A) a computing device comprising a memory member;
(B) at least one data input device and at least one data output device, wherein said data input and output devices are functionally coupled to said computing device;
(C) at least one display device functionally coupled to said computing device;
(D) one or more databases accessible from said computing device;
(E) a color measuring device, and optionally, an appearance measuring device; and
(F) a computing program product operatively residing in said memory member that causes the computing device to perform a computing process comprising the steps of:
(1) receiving vehicle identification data of the vehicle from the data input device;
(2) retrieving vehicle data from a vehicle database accessible from the computing device based on the vehicle identification data;
(3) receiving individual damage data of said cosmetic defects;
(4) generating individual repair data based on the individual damage data and the vehicle data;
(5) retrieving individual cost data based on the individual damage data and the individual repair data;
(6) generating a repair selection by displaying a repair selection question and receiving repair selection input to said repair selection question specifying whether each of said defects is to be repaired;
(7) generating a repair estimate based on the individual damage data, the individual cost data and the repair selection;
(8) optionally, generating a repair schedule for repairing at least one defect specified in the repair selection input; and
(9) outputting the repair data, the repair estimate, or a combination thereof.

15. The system of claim 14, wherein said computing device is a portable computing device.

16. The system of claim 14 further comprising a host computer functionally coupled to the computing device via wired or wireless connections.

17. The system of claim 14, wherein said color measuring device is selected from a colorimeter, a spectrophotometer, or a goniospectrophotometer.

18. The system of claim 14, wherein said appearance measuring device comprises an imaging device.

19. The system of claim 14, wherein said computing device and said color measuring device, and optionally the appearance measuring device, are integrated as one portable device.

20. The system of claim 14, wherein said data input device is selected from a digital input device, an optical input device, an electromagnetic input device, or a combination thereof.

21. The system of claim 14, wherein said display device is selected from a digital display device, an optical display device, a print display device, or a combination thereof.

22. The system of claim 14, wherein said output device is digital display device, an optical display device, a print display device, or a combination thereof.

23. The system of claim 14, wherein the display device is part of the computing device, part of the color measuring device or part of the appearance measuring device.

24. The system of claim 14, wherein said color measuring device or said appearance measuring device is portable.

25. The system of claim 14, wherein said color measuring device and said appearance measuring device are integrated as one device.
